(19) United States
(12) Patent Application Publication
(10) Pub. No.: US 2014/0087187 A1
(43) Pub. Date: Mar. 27, 2014

(54) CULTURED STONE MATERIAL AND RELATED PRODUCTS AND METHODS

(71) Applicant: George C. Hawley, Cornwall (CA)

(72) Inventor: George C. Hawley, Cornwall (CA)

(73) Assignee: AMERICAN SELENITE, LLC, Denver, CO (US)

(21) Appl. No.: 14/122,208

(22) PCT Filed: May 27, 2012
(86) PCT No.: PCT/US12/39780

§ 371 Date: Nov. 25, 2013

Related U.S. Application Data
(60) Provisional application No. 61/491,094, filed on May 27, 2011.
(60) Provisional application No. 61/618,722, filed on Mar. 31, 2012.

(51) Int. Cl. C04B 26/18; B28D 1/00

(52) U.S. Cl. CPC C04B 26/18; B28D 1/00
USPC 428/402; 4/619; 4/584; 4/612; 264/299; 264/331.11; 264/331.18; 264/331.19; 264/331.22; 524/423

(57) ABSTRACT

Cultured stone materials, and products including the same, have a plastic component and particulate calcium sulfate filler, which may be a calcium sulfate filler in the form of calcium sulfate dihydrate filler that provides fire retardancy, and the filer provides other processing and product benefits. The cultured stone materials may be made by converting a mixture of a plastic component and particulate calcium sulfate filler to a rigid shaped form.

### CROSS-REFERENCE TO RELATED APPLICATIONS

This application claims a priority benefit to U.S. Provisional Patent Application No. 61/491,094 filed May 27, 2012, the entire contents of which are incorporated herein by reference. This application claims a priority benefit to U.S. Provisional Patent Application No. 61/618,722 filed Mar. 31, 2012, the entire contents of which are incorporated herein by reference.

### FIELD OF THE INVENTION

The invention relates to cultured stone materials and related products and methods, including with the use of particulate calcium sulfate filler.

### BACKGROUND OF THE INVENTION

Powdered minerals are often added as fillers to liquid resins (plastics) to improve their properties and appearance. The filled products are often referred to as cultured stone, synthetic stone or solid surface materials, which terms are used interchangeably herein. The resins alone tend to be brittle and crack easily, and are highly flammable. The resins tend to be translucent or transparent. The resins used are often polyester resins or acrylic resins. One early cultured stone material included calcium carbonate, in the form of ground limestone, as filler for a product sometimes referred to as “cultured marble”. This material has a dead, chalky appearance. Alumina trihydrate (ATH) has been used as filler and gives a degree of translucency to the cultured stone material, and the resulting cultured stone materials are sometimes referred to as “cultured onyx”. One common cultured stone today, sometimes referred to as “cultured granite”, combines alumina trihydrate filler with colored stone granules. A number of cultured stone products are sold under the Corian® brand of E.I. du Pont de Nemours and Company.

The resin, or plastic, component used to make cultured stone materials are typically highly flammable. This is a problem especially for cultured stone products designed for use in a kitchen environment, such as kitchen countertops and sinks. However, even in other environments there may be a significant fire danger, for example when plumbers use torches to install plumbing for cultured stone products, such as tub and shower units made of cultured stone materials. The International Association of Plumbing and Mechanical Officials has made a specification requiring that such plumbing fixtures be fire resistant. Compounds that contain bromine, chlorine and antimony are very effect fire retardant additives for plastic compositions. Unfortunately, such compounds tend to emit toxic and corrosive fumes when exposed to fire. Alumina trihydrate provides a significant degree of fire retardancy due to release of bound water at high temperatures, and without the noxious emissions associated with bromine, chlorine and antimony compounds. Alumina trihydrate dehydrates over a temperature range of from about 230° C. to about 430° C. There are, however, a number of product and process limitations and undesirable environmental consequences of using alumina trihydrate.

For fire retardant effectiveness in cultured stone, it would be preferred that inorganic hydrate fire retardants, such as alumina trihydrate, are used at high concentrations and with a small particle size. Loading at concentrations of 55 to 60 weight percent, or more, is often desired. With fine particle alumina trihydrate, it has been found that at such high loadings the polymer is too thick to be poured and the mechanical properties of the resulting cultured stone product are unacceptable. J M Huber, a supplier of alumina trihydrate, provides various grades of alumina trihydrate in an average particle size range of 16-95 microns. Finer grades are not recommended due to viscosity concerns. An 8 micron grade is available for use in small amounts to increase filler packing density. Some higher-priced, finer particle size grades are surface-treated with silane, fatty acids or other chemicals to help decrease viscosity so that higher filler loadings may be achieved. These additives may also be used to improve mechanical properties of the cultured stone product. However, even with such surface treatment, loading with fine particulate alumina trihydrate is limited, and the surface treatment adds significantly to the cost of the filler.

Another limitation concerning alumina trihydrate is that, as produced, alumina trihydrate may have a tan color and may contain black specks due to the presence of organics from processing. Commercial alumina trihydrate products may also contain small amounts of iron that reduce the whiteness of the product. For many of the other uses for alumina trihydrate, such as to make aluminum metal or to make alumina abrasives, high whiteness of the alumina trihydrate is not required. However, for use in products such as cultured onyx or cultured granite, a high whiteness is required, and special treatment may be needed to remove impurities from the alumina trihydrate filler for use as a cultured stone filler.

Use of alumina trihydrate also presents significant environmental issues. Alumina trihydrate is a strictly synthetic product, typically extracted from bauxite using caustic soda. In such a process, large amounts of toxic “red mud” are produced, creating an environmental hazard. Also, due to the caustic soda used in its manufacture, the aluminum trihydrate products tend to be alkaline (basic) in pH, which is not preferred for making cultured stone materials.

It would be desirable to address some or all of these limitations associated with the use of aluminum trihydrate as a filler in cultured stone products

### SUMMARY OF THE INVENTION

One aspect of the invention involves a cultured stone material comprising a plastic component and particulate calcium sulfate filler, with the particulate calcium sulfate filler having a weight average particle size of no larger than 3 microns.

A number of feature refinements and additional features are applicable to the first aspect of the invention. These feature refinements and additional features may be used individually or in any combination. As such, each of the following features may be, but are not required to be, used with any other feature or combination of the first aspect.

The plastic component may be any plastic composition with suitable properties for use in solid surface applications. As used herein, “plastic composition” and “resin” or “resin composition” are the same, and refer to a composition composed predominantly of one or more than one polymer and which may include minor amounts of other components, for example plasticizers, processing aids, curing agents and additives that contribute to or participate in cross-linking. “Plastic component” refers to such a resin composition in its initial form prior to processing to make the cultured stone material, during processing and also in a cured and hardened state as present in the final cultured stone material. As will be appreciated, there may be changes in the composition that occur during processing, for example as a result of cross-linking or volatilization of volatile processing aids. The plastic component may be thermoplastic. The plastic component may be thermosetting, which is generally more preferred.

One preferred plastic component comprises polyester resin. The polyester resin may a thermosetting resin. The polyester resin may include one or more than one polymer including polymerization reaction product between dicarboxylic acids (dibasic acids) and dihydroxy alcohols (dihydric alcohols). The polyester resin may initially be unsaturated (e.g., containing ethylenic unsaturation) prior to curing, and may have unsaturated functionality that participates in cross-linking during curing to form the finished cultured stone material. The polyester resin may be based on phthalic acid or its isomers (isophtalic acid, terephthalic acid) or an anhydride of phthalic acid or its isomers (e.g., phthalic anhydride). Ethylenic unsaturated functionality may be provided in a polyester resin, for example, by moieties provided by maleic acid or other unsaturated dicarboxylic acid monomer components used to make the resin.

Another preferred plastic component comprises acrylic resin. The acrylic resin may include one or more than one polymer, including copolymers, of acrylic-based monomer materials (e.g., acrylic acid, methacrylic acid and esters of acrylic acid or methacrylic acid). One preferred acrylic resin comprises poly(methyl methacrylate) (PMMA).

Another preferred plastic component comprises a polyurethane resin. Another preferred plastic component comprises an epoxy resin. Yet another preferred plastic component comprises a resin component selected from the group consisting of a urea-formaldehyde resin, melamine formaldehyde resin and phenol formaldehyde resin.

The particulate calcium sulfate filler may comprise calcium sulfate in any form. In some preferred implementations, the calcium sulfate in the calcium sulfate filler is in the form of calcium sulfate dihydrate, and may be referred to as calcium sulfate dihydrate filler. Calcium sulfate dihydrate filler is particularly preferred for applications where fire retardant properties are important. Calcium sulfate dihydrate filler may function as a significant fire retardant as a result of the bound water within the crystal structure that is released at elevated temperature. The calcium sulfate dihydrate typically dehydrates over a temperature range of from about 80° C. to about 180° C. Calcium sulfate dihydrate filler tends to impart a lustrous “onyx” appearance to a cultured stone material. In other preferred embodiments, the calcium sulfate in the particulate calcium sulfate filler is in the form of anhydrite (anhydrous calcium sulfate), which may be soluble anhydrite or insoluble (so-called dead burned) anhydrite, with insoluble anhydrite being generally more preferred form many implementations. The particulate calcium sulfate filler in which the calcium sulfate is in the form of anhydrite may be referred to as calcium sulfate anhydrite filler. Calcium sulfate anhydrite filler may be preferred in situations when fire retardant properties are not important and when a more opaque, white appearance is desired. Calcium sulfate anhydrite filler tends to impart a more opaque, bright white appearance to the cultured stone material than calcium sulfate dihydrate filler.

The particulate calcium sulfate filler may have a weight average particle size of no larger than 2.5 microns, or no larger than 2 microns. The particulate calcium sulfate filler may have a weight average particle size of at least 0.5 microns, or at least 1 micron. The particulate calcium sulfate filler may have a particle size distribution such that at least 90 weight percent of the particles of the particulate calcium sulfate filler are no larger than 10 microns, or no larger than 7 microns, or no larger than 6 microns, or no larger than 5 microns or no larger than 4 microns, or no larger than 3 microns. The particulate calcium sulfate filler may be of a high purity with respect to the calcium sulfate material (e.g., calcium sulfate dihydrate or anhydrite). The particulate calcium sulfate filler may have a purity of at least 90 percent, or at least 95 percent, or at least 97 percent, or at least 98 percent or at least 99 percent with respect to such calcium sulfate material. By having a purity of at least a certain percentage, it is meant that the calcium sulfate material makes up at least that weight percentage of the particulate calcium sulfate filler.

Calcium sulfate dihydrate of the particulate calcium sulfate dihydrate filler may comprise calcium sulfate dihydrate mineral product. By mineral product, it is meant that the calcium sulfate dihydrate is mined calcium sulfate dihydrate, which may have been beneficiated to the particular particle size and size distribution and purity as present in the particulate calcium sulfate dihydrate filler. In a preferred implementation, the particulate calcium sulfate dihydrate filler contains no, or essentially no, synthetically produced calcium sulfate dihydrate. The calcium sulfate dihydrate of the particulate calcium sulfate dihydrate filler may comprise calcium sulfate dihydrate in a mineral form of gypsum. The calcium sulfate dihydrate of the particulate calcium sulfate dihydrate filler may comprise calcium sulfate dihydrate in a mineral form of selenite.

Anhydrite of calcium sulfate anhydrite filler may comprise anhydrite from calcination of calcium sulfate mineral product, such as calcium sulfate dihydrate mineral product or calcium sulfate hemi-hydrate mineral product. The calcination may be sufficiently severe to form insoluble anhydrite.

The particulate calcium sulfate filler may comprise particles that are surface-treated, for example to permit increased loading of the plastic component with the particulate calcium sulfate filler. Such surface-treated particles may be surface-treated with one or more than one of the following: a silane, an aluminate, a titanate, a zircoaluminate and a fatty acid. Surface treatment of such surface-treated particles may include a material covelantly coupled with or adhered (e.g., adsorbed, physically adsorbed, chemisorbed) to a surface of calcium sulfate particles. Alternatively, the particles of the particulate calcium sulfate filler may not be surface-treated, in that the surface of the particles has not been chemically treated to modify surface properties of the calcium sulfate material of the particles.

The cultured stone material may comprise at least 30 weight percent, at least 40 weight percent, at least 50 weight percent, at least 60 weight percent, at least 65 weight percent, at least 70 weight percent, at least 80 weight percent, at least 90 weight percent or at least 95 weight percent of the particulate calcium sulfate filler. The cultured stone material may comprises no more than 96 weight percent, no more than 95 weight percent, no more than 90 weight percent, no more than 80 weight percent, no more than 70 weight percent, no more than 65 weight percent or no more than 60 weight percent of the particulate calcium sulfate filler. In one implementation, for example for thermoset casting applications, the cultured stone material may comprise the particulate calcium sulfate filler in an amount in a range of from 55 weight percent to 70 weight percent. In another implementation, for example for compression molding applications, the cultured stone material may comprise at least 95 weight percent of the calcium sulfate filler

The cultured stone material may comprise at least 3 weight percent, at least 5 weight percent, at least 10 weight percent, at least 20 weight percent, at least 30 weight percent, at least 35 weight percent, at least 40 weight percent or at least 50 weight percent of the plastic component. The cultured stone material may comprise no more than 70 weight percent, no more than 60 weight percent, no more than 50 weight percent, no more than 40 weight percent, no more than 35 weight percent, no more than 30 weight percent, no more than 20 weight percent, no more than 10 weight percent or no more than 5 weight percent of the plastic component. In one implementation, for example for thermoset casting applications, the cultured stone material may comprise the plastic component in an amount in a range of from 25 weight percent to 45 weight percent. In another implementation, for example for compression molding applications, the cultural stone material may comprise no more than 5 weight percent of the polymer component.

The cultured stone material may comprise one or more than one minor component that is different than the particulate calcium sulfate filler and the plastic component. Such a minor component may comprise a decorative material. Such a minor component may comprise a pigment. Such a minor component may comprise rock granules.

A particulate calcium sulfate dihydrate filler may be a first fire retardant filler and the cultured stone material may comprise one or more than one other fire retardant filler (e.g., a second fire retardant filler, a third fire retardant filler, etc.) different than the particulate calcium sulfate dihydrate filler, for example including an inorganic hydrate other than calcium sulfate dihydrate. Such an other fire retardant filler may have a dehydration temperature range different than the dehydration temperature range for calcium sulfate dihydrate, for example having an initial dehydration temperature that is higher than the initial dehydration temperature of the first fire retardant filler or even having an initial dehydration temperature that is higher than a final dehydration temperature of the first fire retardant filler. Such an other fire retardant filler may be alumina trihydrate or magnesium dihydrate. The cultured stone material may comprise two or more than two different fire retardant fillers (e.g., calcium sulfate dihydrate and one or both of magnesium dihydrate and aluminum trihydrate). Magnesium dihydrate may be in the form of the mineral brucite. Such an other fire retardant filler may be in particulate form, and for example may have any of the particle size and size distribution characteristics as described for the particulate calcium sulfate dihydrate filler, or may have different particle size and size distribution characteristics than as described for the particulate calcium sulfate dihydrate filler. When the cultured stone material comprises more than one different fire retardant filler, the cultured stone material may comprise the fire retardant fillers at a combined weight percentage (sum of the individual weight percentages of all of the fire retardant fillers) according to any of the weight percentages described above for the particulate calcium sulfate dihydrate filler. When multiple different fire retardant fillers are present in the cultured stone material, the particulate calcium sulfate dihydrate filler may be present at a larger weight percentage concentration than each other fire retardant filler. Any such other fire retardant filler may be surface-treated, for example as described above for the particulate calcium sulfate filler. By fire retardant filler, it is meant an inorganic material, which may be a mineral or a synthetic material, capable of giving off water as it thermally decomposes or which otherwise contributes to fire retardancy. In one preferred implementation, each fire retardant filler in the cultured stone material includes an inorganic hydrate.

The cultured stone material may be in a rigid shaped form, such as a particular form for a product, or portion of a product, designed for a particular application.

A second aspect of the invention involves a product comprising a cultured stone material comprising a plastic component and a particulate calcium sulfate filler, wherein the particulate calcium sulfate filler has a weight average particle size of no larger than 3 microns.

A number of feature refinements and additional features are applicable to the second aspect of the invention. These feature refinements and additional features may be used individually or in any combination. As such, each of the following features may be, but are not required to be used with any feature combination of the second aspect.

The cultured stone material may be a cultured stone material according to the first aspect of the invention, including any feature or combination of any of the features described with respect to the first aspect of the invention.

The product of the second aspect of the invention may include the cultured stone material formed into any product form. The product may, for example, be any of the following: a countertop, a sink, a tub, a spa, a shower unit, simulated brick, tile, simulated stone, a wall sheet, a bowling ball, a button, or a figurine. The product may be a supporting base for machinery.

A third aspect of the invention involves a method for making a cultured stone material. The method comprises converting a mixture to a rigid shaped form. The mixture comprises a plastic component and a particulate calcium sulfate filler, wherein the particulate calcium sulfate filler has a weight average particle size of no larger than 3 microns.

A number of feature refinements and additional features are applicable to the third aspect of the invention. These feature refinements and additional features may be used individually or in any combination. As such, each of the following features may be but are not required to be used with any other feature or combination of the third aspect.

The method may comprise, prior to the converting, forming the mixture into a shape, which forming may include introducing the mixture into a cavity of a mold. The mixture may fill and take on the shape of the mold.

The converting may comprise a hardening or solidifying of the plastic component to a rigid, solid or hardened form that binds the particulate calcium sulfate filler in a composite structure of the final cultured stone material. The converting may comprise curing, or setting, the mixture, for example as may be the case for a thermosetting plastic component. Such curing may occur after the mixture has been formed into a desired shape for the final product, such as may be the case during a casting operation, or may occur while the mixture is being shaped into its final form, such as may be the case during a compression molding operation. The curing may involve chemical changes to the mixture. For example, the curing may comprise cross-linking of polymer of the plastic component. The mixture may include one or more than one agent that participates in such cross-linking, for example an agent with unsaturated functionality (e.g., styrene) that is capable of participating in cross-linking reactions with unsaturated functionality of a polymer being cross-linked. The converting may include hardening or solidification on cooling, for example as may be the case for a thermoplastic plastic component. During the converting, the plastic component may be transformed from a liquid form to a solid form, or from a low-viscosity flowable form to a rigid form.

The method may comprise cooling the plastic component from an elevated temperature. This may occur during the converting, for example as might be the case for a thermosetting plastic component, or may occur following the converting, for example as might be the case for a thermoplastic plastic component. Prior to the cooling, the method may comprise heating the mixture to an elevated temperature. Such heating may occur prior to forming the mixture into a desire shape, for example as might be the case for a thermoplastic plastic component, or may occur after or during such forming, for example as might be the case of a thermoplastic plastic component. In one preferred implementation of the method, the temperature of the mixture, and especially particulate calcium sulfate dihydrate filler, does not exceed a maximum temperature selected from the group consisting of 80 C.°, or 70 C.° or 60 C°. Maintaining such a low maximum temperature during processing may prevent dehydration of calcium sulfate dihydrate in the mixture.

Prior to the converting, the mixture may have a pourable viscosity, for example suitable for pouring the mixture into a cavity of a mold. The mixture may have such a pourable viscosity at room temperature, for example as might be the case for a thermosetting plastic component, or the mixture may have such a pourable viscosity at an elevated temperature, for example as might be the case for a thermoplastic plastic component.

The method may comprise, prior to the converting, preparing the mixture. Preparing the mixture may include mixing the particulate calcium sulfate filler with the plastic component. The preparing may include mixing with the particulate calcium sulfate filler and the plastic component one or more other components, for example any of the other components described with respect to the first aspect of the invention (e.g., additional fire retardant filler, a decorative component).

The plastic component for the method may be or have any feature or combination of any other features as described with respect to the first aspect of the invention, for example comprising an acrylic resin, polyester resin or other resin, or being thermosetting or thermoplastic). At commencement of the processing of the method, the plastic component will be in an initial state, which may change during processing, such as described above with respect to the first aspect of the invention (e.g., due to volatilization or reaction of materials initially within the plastic component).

The particulate calcium sulfate filler may be or have any feature or combination of features as described with respect to the first aspect of the invention.

The method may comprise any suitable method for carrying out the processing of the method. The method may comprise casting the mixture, for example pouring the mixture into a cavity of a mold. The method may comprise compression molding the mixture.

The cultured stone material made according to the method may be or include any feature or combination of any of the features described with respect to the first aspect of the invention. The rigid shaped form may be or include any feature or combination of any of the features described with respect to the first aspect of the invention or the second aspect of the invention.

A fourth aspect of the invention involves a use of particulate calcium sulfate filler having a weight average particle size of no larger than 3 microns as a fire retardant filler in a cultured stone material.

A number of feature refinements and additional features are applicable to the fourth aspect of the invention. These feature refinements and additional features may be used individually or in any combination. As such, each of the following features may be but are not required to be used with any other feature or combination of the fourth aspect.

The particulate calcium sulfate filler may be or have any feature of combination of any of the features as described with the first aspect of the invention. The cultured stone material may be or have any feature or combination of any of the features as described with the respect to the first aspect of the invention. The cultured stone material may be or be a part of any product as describe with respect to the second aspect of the invention.

### BRIEF DESCRIPTION OF THE DRAWINGS

FIG. 1 is a generalized process block diagram of one embodiment of a method of the invention for making cultured stone material.

FIG. 2 is a generalized process block diagram of another embodiment of a method of the invention for making cultured stone material.

FIG. 3 is a generalized process block diagram of another embodiment of a method of the invention for making cultured stone material.

FIG. 4 is a generalized process block diagram of another embodiment of a method of the invention for making cultured stone material.

FIG. 5 is a generalized process block diagram of another embodiment of a method of the invention for making cultured stone material

### DETAILED DESCRIPTION

As used herein, “particulate” and “particulate form” mean that a material is in the form of a batch of particles, regardless of whether the batch of particles is separate from other materials or is intimately mixed with other materials (e.g., particulate filler mixed with plastic component).

By “dehydration” of a material (e.g., an inorganic hydrate filler), it is meant the release (evolution) of bound water from the crystal of the material as the crystal structure decomposes (e.g., calcines). Dehydration typically occurs over a temperature range, with the lower end of such temperature range referred to herein as an “initial dehydration temperature” and the upper end of such temperature range referred to herein as a “final dehydration temperature”. The fire retardant effect of dehydration of hydrate fillers in relation to a cultured stone product involves the evolved water vaporizing, absorbing heat and cooling the cultured stone. The water vapor also dilutes flammable vapors given off by the decomposing polymer component of the cultured stone. Also, the mineral base (calcine) left after all water is evolved is a high temperature refractory that seals off the surface of the polymer so that heat cannot pass inwards, and that flammable vapors cannot pass outwards to be ignited. To function in this manner, hydrate filler loadings of 55-60 weight percent, or more, are generally required. Also, a finer particle size of the hydrate filler provides higher surface area for heat transfer, promoting quick and effective evolution of the water.

In referring to a “plastic component”, the reference is to a component, which may be a mixture, a major part of which is made up of one or more than one polymer. The term is used to refer to the same plastic component in initial processing feedstocks and final cultured stone material and products including such cultured stone material, even though, as will be appreciated the composition and properties of the plastic component may change and be different at different points during processing to manufacture a cultured stone material, and may be different between the plastic component as a process feedstock, in an initial mixture with a particulate calcium sulfate dihydrate filler, and in a final cultured stone material. When a plastic component is referred to as a “resin” (e.g., acrylic resin, polyester resin, polyurethane resin, epoxy resin, urea-formaldehyde resin, melamine formaldehyde resin, phenol formaldehyde resin) in the context of a cultured stone material, it will be appreciated that the reference is to the initial feedstock resin, but the composition and properties of the plastic component in the cultured stone material will not be those of such initial feedstock resin, but the composition and properties of the plastic component as actually present in the cultured stone material, the reference to the feedstock resin merely being for convenience of description.

The discussion below is exemplified primarily with reference to the use of calcium sulfate dihydrate filler, but except in relation to fire retardancy and issues with the bound water of the calcium sulfate dihydrate, the discussion applies also to calcium sulfate anhydrite filler.

Calcium sulfate dihydrate (CSD) has many properties that make it desirable for use as a filler in cultured stone materials, especially when an “onyx” effect is desired. Table 1 shows properties of some components that may be used in cultured stone materials. As seen in Table 1, calcium sulfate dihydrate has a refractive index that is lower than, and closer to the refractive index of polyester resin and acrylic resin, than the listed common mineral fillers used to make cultured stone materials and also than the other listed fire retardant fillers. The low refractive index is important to avoid a chalky appearance and promote higher translucency. Calcium sulfate dihydrate also has a lower specific gravity than the listed common mineral fillers and the other listed fire retardant minerals. This provides a benefit in that for any give weight percentage loading of the calcium sulfate dihydrate in a plastic component, the calcium sulfate dihydrate will occupy a larger volume than those other materials. Calcium sulfate dihydrate has a lower Mohs hardness than the listed common mineral fillers and the other listed fire retardant fillers, which is beneficial to reduce wear on processing equipment. Calcium sulfate dihydrate has a neutral pH, compared to a significantly basic (alkaline) pH of the listed common mineral fillers and the other listed fire retardant fillers. The neutral pH for calcium sulfate dihydrate provides an advantage in that calcium sulfate dihydrate filler should not react with polymers or catalysts which are likely to be used in the manufacture of cultured stone materials. Such reactions can be detrimental by causing viscosity increase, polymer degradation and corrosion of metal parts.

Also, the use of calcium sulfate dihydrate mineral (mined material as opposed to synthetic material) is advantageous from an environmental standpoint. Manufacture of filler from mineral calcium sulfate dihydrate does not involve the same environmental problems as are associated with manufacture of the synthetic alumina trihydrate filler. Manufacture of synthetically-produced magnesium dihydrate (but not brucite) also suffers from serious environmental issues, which are avoided with the use of calcium sulfate dihydrate mineral. The advantage of using calcium sulfate dihydrate mineral is especially pronounced when the mineral resource from which calcium sulfate dihydrate is mined is of high natural purity, because only minimal beneficiation will be required to prepare the desired particulate filler, which may involve primarily comminution and sizing to a desired small particle size and size distribution. The environmental benefits of using calcium sulfate dihydrate mineral in place of some or all of the alumina trihydrate currently used in cultured stone materials could be very significant given the high volume of alumina trihydrate filler currently used in such applications.

Surprisingly, it has been found that a particulate filler of high purity calcium sulfate dihydrate mineral particles with very fine particle size having a weight average particle size of about 2 microns mixed to a filler loading of about 60 weight percent with representative thermosetting resin for cultured stone manufacture (a polyester casting resin) resulted in a mixture that had a pourable viscosity suitable for casting processing in a mold. This was the case even without surface treatment of the calcium sulfate dihydrate. After curing in the form of a shaped figurine, the finished cultured stone material showed good translucency. The desirable high loading with good viscosity is believed to be due at least in part to the granular morphology of the calcium sulfate dihydrate, as opposed for example to the platelet morphology of alumina trihydrate. It is believed that this 60 weight percent loading may be significantly increased through particle size and size distribution optimization (perhaps including a dimodal size distribution for better packing density) and/or through appropriate surface treatment. The granular morphology should also be beneficial for processing dough-like compounds processed under pressure (e.g., compression molding).

TABLE 1
Properties of Some Materials

| | Specific | | | | |
|---|---|---|---|---|---|
| | Gravity | Mohs | Refractive | | |
| Substance | g./cc. | Hardness | Index | Morphology | pH |
| Common | | | | | |
| Mineral | | | | | |
| Fillers | | | | | |
| Calcium | 2.71 | 3.0 | 1.66 | Hexagonal | 9.5-10.0 |
| carbonate | | | | granular | |
| Wollastonite | 2.9 | 4.5 | 1.63 | Monoclinic | 11 |
| | | | | lathes | |
| Talc | 2.7-2.85 | 1.0 | 1.59 | Rhombic | 9 |
| | | | | platelet | |
| Fire | | | | | |
| Retardant | | | | | |
| Fillers | | | | | |
| Alumina | 2.42 | 2.5-3.5 | 1.57 | Hexagonal | 8.4-10.2 |
| trihydrate | | | | platelet | |
| (ATH) | | | | | |
| Calcium | 2.32 | 1.5-2.0 | 1.52 | Monoclinic | 7.3 |
| sulfate | | | | granular | |
| dihydrate | | | | | |
| (CSD) | | | | | |
| Brucite | 2.38-2.40 | 2.5-3.0 | 1.58 | Hexagonal | 10.5 |
| (MDH) | | | | platelet | |
| Resins | | | | | |
| Polyester | 1.01-1.20 | very low | 1.54-1.55 | amorphous | |
| resin | | | | | |
| Acrylic resin | 1.19 | very low | 1.48-1.50 | amorphous | |

Table 2 shows some additional properties for the same fire retardant fillers and resins as are shown in Table 1. As shown in Table 2, the dehydration temperature range for calcium sulfate dihydrate is significantly lower than for the other listed fire retardant fillers. This dehydration range matches much better with the decomposition temperature at which themoset casting resins in particular decompose, providing a significant advantage over the use of the other listed fire retardants alone. As can be seen from the dehydration temperature ranges shown for alumina trihydrate and brucite, a cultured stone material including both a particulate calcium sulfate dihydrate filler and one or both of the other fillers would provide even better protection over a wider range of temperatures. In particular, the dehydration temperatures ranges of calcium sulfate dihydrate and alumina trihydrate indicate that a combination of using both of those two fillers is highly desirable, because the initial dehydration temperature (230° C.) for alumina trihydrate is relatively close to the final decomposition temperature of calcium sulfate dihydrate (180 C).

TABLE 2
Properties of Some Fire Retardant Fillers

| | | Approximate |
|---|---|---|
| | | dehydration |
| | Combined | temperature range, |
| Substance | water, wt % | deg C. |
| Alumina trihydrate | 34.6 | 230-430 |
| (ATH) | | |
| Calcium sulfate | 20.9 | 80-180 |
| dihydrate (CSD) | | |
| Brucite (MDH) | 30.9 | 330-430 |
| | | Onset of |
| | | Decomposition, |
| Resins | | deg C. |
| Polyester resin | None | 270 |
| Acrylic resin | None | 300 |

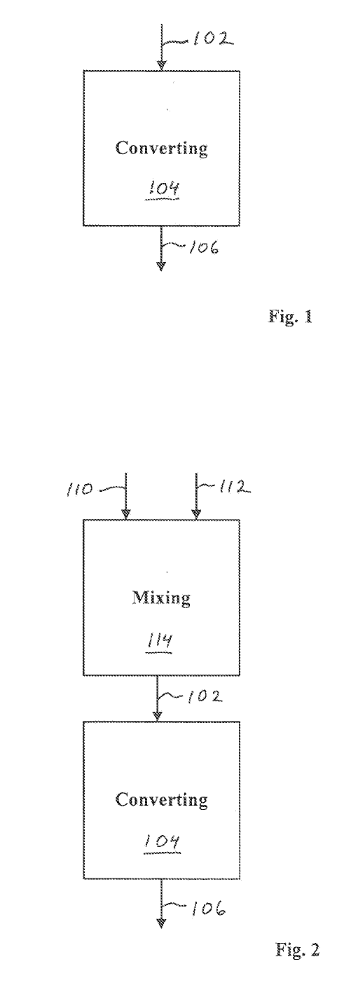

Reference is now made to FIGS. 1-5. Like reference numerals are used to refer to like features.

FIG. 1 shows a generalized process block diagram for one embodiment of a method of the third aspect of the invention. As shown in FIG. 1, a mixture 102, comprising a plastic component and a calcium sulfate dihydrate filler, is subjected to a converting 104 step. During the converting 104, the mixture 102 is converted to a rigid shaped form 106 of cultured stone material.

FIG. 2 shows the generalized block diagram of another embodiment of a method of the third aspect of the invention. As shown in FIG. 2, a plastic component 110 and a calcium sulfate dihydrate filler 112 are mixed in a mixing 114 step to prepare the mixture 102. The mixture 102 is processed through the converting 104 step to prepare the rigid shaped form 106 similar to FIG. 1.

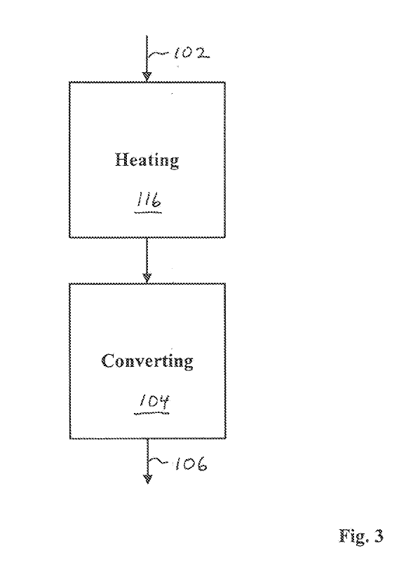

FIG. 3 shows a generalized process block diagram of another embodiment of a method of the third aspect of the invention. As shown in FIG. 3, the mixture 102 is subjected to a heating 116 step to raise the temperature of the mixture 102 to an elevated temperature prior to being subjected to the converting 104 to prepare the rigid shaped form 106. The processing of FIG. 3 may be appropriate, for example, when the mixture 102 includes a thermoplastic plastic component, and the converting 104 may include cooling the mixture after it is formed into the desired shape at elevated temperature.

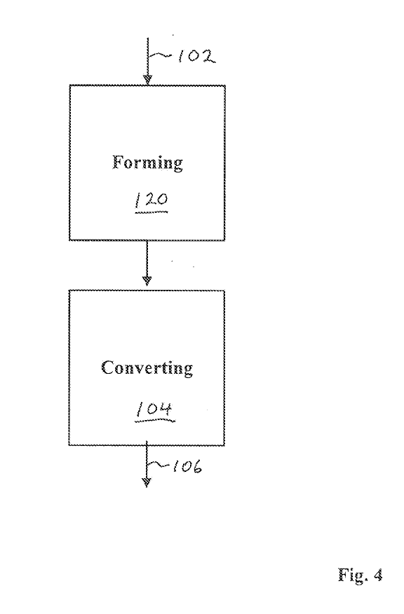

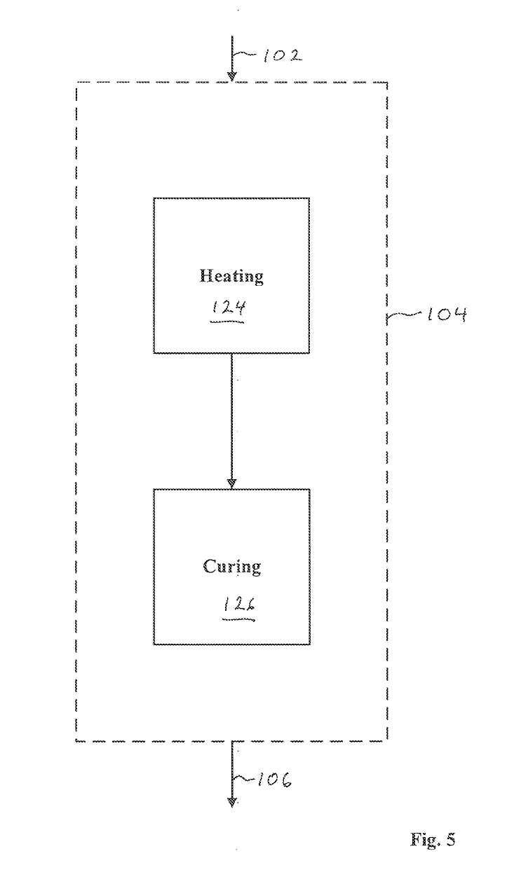

FIG. 4 shows a generalized process block diagram of another embodiment of a method of the third aspect of the invention. As shown in FIG. 4, the mixture 102 is subjected to a forming 120 step, during which the mixture 102 is formed into a shape prior to subjecting the mixture 102 to the converting 104 to prepare the rigid shaped form 106.

FIG. 5 shows a generalized process block diagram of another embodiment of a method of the third aspect of the invention. As shown in FIG. 5, the mixture 102 is subjected to the converting 104 to prepare the rigid shaped form 106. The converting 104 includes sub-steps of heating 124 the mixture 102 followed by curing 126. The processing of FIG. 5, for example, may be appropriate for processing the mixture 102 when the mixture 102 contains a thermosetting plastic component.

The foregoing discussion of the invention has been presented for purposes of illustration and description and to disclose the best mode contemplated for practicing the invention. The foregoing is not intended to limit the invention to only the form or forms specifically disclosed herein. Although the description of the invention has included description of one or more embodiments and certain variations and modifications, other variations and modifications are within the scope of the invention, e.g., as may be within the skill and knowledge of those in the art after understanding the present disclosure. It is intended to obtain rights which include alternative embodiments to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter. Furthermore, any feature described with respect to any disclosed aspect, embodiment, implementation, variation or configuration may be combined in any combination with one or more features of any other aspect, embodiment, implementation, variation or configuration.

The terms “comprising”, “containing”, “including” and “having”, and grammatical variations of those terms, are intended to be inclusive and nonlimiting in that the use of such terms indicates the presence of some condition or feature, but not to the exclusion of the presence also of any other condition or feature. The use of the terms “comprising”, “containing”, “including” and “having”, and grammatical variations of those terms in referring to the presence of one or more components, subcomponents or materials, also include and is intended to disclose the more specific embodiments in which the term “comprising”, “containing”, “including” or “having” (or the variation of such term) as the case may be, is replaced by any of the narrower terms “consisting essentially of” or “consisting of” or “consisting of only” (or the appropriate grammatical variation of such narrower terms). For example, the phrase “the plastic component comprises acrylic resin” also includes and also discloses the more specific narrower embodiments of “the plastic component consists essentially of acrylic resin”, “the plastic component consists of acrylic resin” and “the plastic component consists of only acrylic resin”. Examples of various features have been provided for purposes of illustration, and the terms “example”, “for example” and the like indicate illustrative examples that are not limiting and are not to be construed or interpreted as limiting a feature or features to any particular example. The term “at least” followed by a number (e.g., “at least one”) means that number or more than that number. The term at “at least a portion” means all or a portion that is less than all. The term “at least a part” means all or a part that is less than all.

What is claimed is:

1. A cultured stone material, comprising a plastic component and particulate calcium sulfate filler, the particulate calcium sulfate filler having a weight average particle size of no larger than 3 microns.

2. A cultured stone material according to claim 1, wherein the plastic component comprises polyester resin.

3. A cultured stone material according to claim 1, wherein the plastic component comprises acrylic resin.

4. A cultured stone material according to claim 1, wherein the plastic component comprises polyurethane resin.

5. A cultured stone material according to claim 1, wherein the plastic component comprises epoxy resin.

6. A cultured stone material according to claim 1, wherein the plastic component comprises a member selected from the group consisting of urea-formaldehyde resin, melamine formaldehyde resin and phenol formaldehyde resin.

7. A cultured stone material according to any one of claims 1-6, wherein the plastic component is thermoplastic.

8. A cultured stone material according to any one of claims 1-6, wherein the plastic component is thermosetting.

9. A cultured stone material according to any one of claims 1-8, wherein the particulate calcium sulfate filler has a weight average particle size of no larger than 2 microns.

10. A cultured stone material according to any one of claims 1-9, wherein at least 90 weight percent of the particles of the particulate calcium sulfate filler are no larger than 6 microns.

11. A cultured stone material according to any one of claims 1-10, wherein the calcium sulfate filler has a purity of at least 98 weight percent.

12. A cultured stone material according to any one of claims 1-11, wherein the particulate calcium sulfate filler is calcium sulfate dihydrate filler.

13. A cultured stone material according to claim 11, wherein the calcium sulfate dihydrate filler comprises calcium sulfate dihydrate mineral product.

14. A cultured stone material according to any one of claims 1-11, wherein the particulate calcium sulfate filler is a calcium sulfate anhydrite filler.

15. A cultured stone material according to any one of claims 1-14, wherein calcium sulfate particles of the particulate calcium sulfate filler are surface-treated.

16. A cultured stone material according to any one of claims 1-15, comprising at least 30 weight percent of the particulate calcium sulfate filler.

17. A cultured stone material according to any one of claims 1-16, comprising at least 50 weight percent of the particulate calcium sulfate filler.

18. A cultured stone material according to any one of claims 1-17, comprising at least 60 weight percent of the particulate calcium sulfate filler.

19. A cultured stone material according to any one of claims 1-18, comprising no more than 96 weight percent of the particulate calcium sulfate filler.

20. A cultured stone material according to any one of claims 1-19, comprising at least 5 weight percent of the plastic component.

21. A cultured stone product according to any one of claims 1-20, wherein the particulate calcium sulfate filler is a calcium sulfate dihydrate filler and the calcium sulfate dihydrate filler is a first fire retardant filler; and
the cultured stone material comprises a second fire retardant filler that is different than the first fire retardant filler.

22. A cultured stone material according to claim 21, wherein the second fire retardant filler has an initial dehydration temperature that is higher than an initial dehydration temperature of the first fire retardant filler.

23. A cultured stone material according to either one of claim 21 or claim 22, wherein the second fire retardant filler is magnesium dihydrate.

24. A cultured stone material according to either one of claim 21 or claim 22 wherein the second inorganic dihydrate filler is aluminum trihydrate.

25. A cultured stone material according to any one of claims 1-24, comprising a particulate decorative component that is different than the particulate calcium sulfate filler.

26. A cultured stone material according to claim 25, wherein the particulate decorative material comprises rock granules.

27. A cultured stone material according to claim 1, wherein:
at least 90 weight percent of the particles of the particulate calcium sulfate filler are no larger than 10 microns; and
the calcium sulfate filler has a purity of at least 98 weight percent.
the cultured stone material comprises at least 60 weight percent of the particulate calcium sulfate filler;
the cultured stone material comprises at least 20 weight percent of the plastic component; and
the plastic component comprises a member selected from the group consisting of polyester resin, acrylic resin, polyurethane resin, epoxy resin, urea-formaldehyde resin, melamine formaldehyde resin and phenol formaldehyde resin.

28. A cultured stone material according to claim 27, wherein at least 90 weight percent of the particles of the particulate calcium sulfate filler are no larger than 6 microns

29. A cultured stone material according to claim 28, wherein particulate calcium sulfate filler has a weight average particle size of no larger than 2 microns.

30. A cultured stone material according to claim 29, wherein calcium sulfate particles of the particulate calcium sulfate filler are surface-treated.

31. A cultured stone material according to claim 30, wherein the cultured stone material comprises a particulate decorative component comprising rock granules.

32. A cultured stone material according to claim 31, wherein the particulate calcium sulfate filler is a calcium sulfate mineral product.

33. A cultured stone material according to any one of claims 27-32, wherein the particulate calcium sulfate filler is a calcium sulfate dihydrate filler.

34. A cultured stone material according to claim 33, wherein the calcium sulfate dihydrate filler is a first fire retardant filler;
the cultured stone material comprises a second fire retardant filler that is different than the first fire retardant filler; and
the first fire retardant filler is present in the cultured stone material at a larger weight percentage concentration than the second fire retardant filler.

35. A cultured stone material according to claim 34, wherein the second fire retardant filler is aluminum trihydrate.

36. A cultured stone material according to claim 34, wherein the second fire retardant filler is magnesium dihydrate

37. A cultured stone material according to claim 36, wherein the magnesium dihydrate is in the form of the mineral brucite.

38. A cultured stone material according to any one of claims 27-32, wherein the particulate calcium sulfate filler is an anhydrite filler.

39. A cultured stone material according to claim 38, wherein the anhydrite is insoluble anhydrite.

40. A product comprising the cultured stone material of any one of claims 27-32, wherein the product is in a form selected from the group consisting of a sink, a tub, a spa and a shower unit.

41. A product comprising the cultured stone material of any one of claims 1-39.

42. A product according to claim 41, in the form of a countertop.

43. A product according to claim 41, in the form of a sink.

44. A method for making a cultured stone material, the method comprising converting a mixture to a rigid shaped form, wherein the mixture comprises a plastic component and a particulate calcium sulfate filler, with the particulate calcium sulfate filler having a weight average particle size of no larger than 3 microns.

45. A method according to claim 44, comprising, prior to the converting, forming the mixture into a shape.

46. A method according to claim 45, wherein the forming comprises introducing the mixture into a cavity of a mold.

47. A method according to any one of claims 44-46, wherein the converting comprises curing the mixture.

48. A method according to claim 47, wherein the curing comprises cross-linking polymer of the plastic component.

49. A method according to any one of claims 44-48, wherein the converting comprises cooling the plastic component from an elevated temperature.

50. A method according to any one of claims 44-49, wherein prior to the converting the mixture has a pourable viscosity.

51. A method according to any one of claims 44-50, comprising prior to the converting, preparing the mixture, the preparing comprising mixing the particulate calcium sulfate filler with the plastic component.

52. A method according to any one of claims 44-51, wherein the plastic component comprises acrylic resin.

53. A method according to any one of claims 44-51, wherein the plastic component comprises polyester resin.

54. A method according to any one of claims 44-51, wherein the plastic component comprises polyurethane resin.

55. A method according to any one of claims 44-51, wherein the plastic component comprises epoxy resin.

56. A method according to any one of claims 44-51, wherein the plastic component comprises a member selected from the group consisting of urea-formaldehyde resin, melamine formaldehyde resin and phenol formaldehyde resin.

57. A method according to any one of claims 44-56, wherein the plastic component is thermosetting.

58. A method according to any one of claims 44-56, wherein the plastic component is thermoplastic.

59. A method according to any one of claims 44-58, comprising casting the mixture.

60. A method according to any one of claims 44-58, comprising compression molding the mixture.

61. The method according to any one of claims 44-60, wherein the particulate calcium sulfate filler is as described in any of claims 1-39.

62. A method according to any one of claims 44-61, wherein the plastic component is as described in any of claims 1-39.

63. A method according to any one of claims 44-62, wherein the rigid shaped form is a product according to any of claims 40-43.

64. A method according to any one of claims 44-63, wherein the cultured stone material is according to any one of claims 1-39.

65. Use of particulate calcium sulfate filler having a weight average particle size of no larger than 3 microns as a filler in a cultured stone material.

66. A use according to claim 65, wherein the particulate calcium sulfate filler is as described in any one of claims 1-39.

67. A use according to either one of claim 65 or 66, wherein the cultured stone material is according to any of claims 1-39.

68. A use according to any one of claims 65-67, where in the use is as a fire retardant filler in a cultured stone material.
